(19) United States
(12) Patent Application Publication
(10) Pub. No.: US 2015/0293411 A1
(43) Pub. Date: Oct. 15, 2015

(54) METHOD OF MANUFACTURING DISPLAY PANEL

(71) Applicant: Samsung Display Co., Ltd., Yongin-City (KR)

(72) Inventors: Sejoon Oh, Suwon-si (KR); Kyung-Bae Kim, Seoul (KR); Sakae Tanaka, Suwon-si (KR); Je Hyeong Park, Hwaseong-si (KR); Yongwoo Hyung, Suwon-si (KR)

(21) Appl. No.: 14/608,076

(22) Filed: Jan. 28, 2015

(30) Foreign Application Priority Data
Apr. 9, 2014 (KR) 10-2014-0042457

(51) Int. Cl. G02F 1/1337; G02F 1/1341

(52) U.S. Cl. CPC G02F 1/133788; G02F 1/1341

(57) ABSTRACT

A manufacturing method of a liquid crystal display panel includes applying a first electric field to a first area of a liquid crystal layer and irradiating a light to the first area to form first and second cured layers, which pre-tilt the first liquid crystal molecules at a first angle, applying a second electric field having an intensity different from the first electric field to the second area and irradiating the light to the second area to form third and fourth cured layers, which pre-tilt the second liquid crystal molecules at a second angle different from the first angle.

### CROSS-REFERENCE TO RELATED APPLICATION

This U.S. non-provisional patent application claims priority under 35 U.S.C. §119 of Korean Patent Application No. 10-2014-0042457, filed on Apr. 9, 2014, the contents of which are hereby incorporated by reference in its entirety.

### BACKGROUND

1. Field of Disclosure

The present disclosure relates to a method of manufacturing a display panel. More particularly, the present disclosure relates to a method of manufacturing a liquid crystal display panel.

2. Description of the Related Art

A liquid crystal display includes two transparent substrates and a liquid crystal layer disposed between the two substrates and drives liquid crystal molecules in the liquid crystal layer to control a light transmittance in each pixel, thereby displaying a desired image.

In a vertical alignment mode among various operation modes of the liquid crystal display, the liquid crystal molecules are vertically aligned when an electric field is applied between the two substrates to transmit light, and thus the image is displayed.

### SUMMARY

The present disclosure provides a method of manufacturing a liquid crystal display panel having improved visibility.

One aspect of the invention provides a method of manufacturing a liquid crystal display device, the method comprising: providing an intermediate product comprising a first panel, a second panel and a liquid crystal layer disposed between the first and second panel, the liquid crystal layer comprising liquid crystal molecules and a photo-curable material, the intermediate product comprising a first area and a second area next to the first area when viewed in a direction perpendicular to a major surface of the first panel; applying a first electric field to the liquid crystal layer; irradiating light to the liquid crystal layer in the first area while applying the first electric field to cure the photo-curable material in the first area thereby forming cured layers of the photo-curable material over the first and second panels in the first layer and pre-tilting the liquid crystal molecules between the cured layers in the first area to have a first angle with respect to the direction; applying a second electric field having an intensity different from that of the first electric field to the liquid crystal layer in the second area; and irradiating light to the liquid crystal layer in the second area while applying the second electric field to cure the photo-curable material in the second area, thereby forming cured layers of the photo-curable material over the first and second panels in the second area and pre-tilting the liquid crystal molecules between the cured layers in the second area to have a second angle with respect to the direction, the second angle being different from the first angle, wherein the light is not irradiated to the liquid crystal layer in the second area when irradiating the liquid crystal layer in the first area.

In the foregoing method, the photo curable material may comprise side chain liquid crystal polymer. The first panel may comprise first and second pixel electrode and the second panel may comprise a reference electrode, wherein the first area overlaps the first pixel electrode when viewed in the direction and the first electric field is applied between the first pixel electrode and the reference electrode, wherein the second area overlaps the second pixel electrode when viewed in the direction and the second electric field is applied between the second pixel electrode and the reference electrode. The first panel may comprise a pixel electrode and the second panel may comprise a reference electrode, wherein the first and second areas overlap first and second portions of the pixel electrode, respectively, when viewed in the direction, wherein the first and second electric fields are applied between the pixel electrode and the reference electrode.

Embodiments of the inventive concept provide a method of manufacturing a liquid crystal display panel including forming a first substrate including a first base substrate and a first alignment layer, forming a second substrate including a second base substrate and a second alignment layer, the second substrate opposing first substrate, forming a liquid crystal layer between the first and second alignment layers, the liquid crystal layer including a first area comprising first liquid crystal molecules and second area comprising second liquid crystal molecules, applying a first electric field to the first area of the liquid crystal layer, irradiating a light to the first area to form first and second cured layers, over the first and second alignment layers, respectively, the first and second cured layers are configured to pre-tilt the first liquid crystal molecules at a first angle, applying a second electric field having an intensity different from that of the first electric field to the second area, and irradiating the light to the second area to form third and fourth cured layers, over the first and second alignment layers, respectively, the third and fourth cured layers are configured to pre-tilt the second molecules at a second angle different from the first angle.

The forming of the first and second cured layers includes shadow-masking the second area using a first mask including a first opening formed therethrough and corresponding to the first area and irradiating the light to the first area, and the forming of the third and fourth cured layers includes shadow-masking the first area using a second mask including a second opening formed therethrough and corresponding to the second area and irradiating the light to the second area.

The forming of the first and second cured layers includes providing the light to the first area using a digital exposure unit while not providing the light to the second area, and the forming of the third and fourth cured layers includes providing the light to the second area using the digital exposure while not providing the light to the first area.

The forming of the first substrate includes forming a pixel electrode between the first base substrate and the first alignment layer and the forming of the second substrate includes forming a reference electrode between the second base substrate and the second alignment layer.

The forming of the first and second cured layers further comprises applying the pixel electrode with a first voltage and the reference electrode with a second voltage having a level different from a level of the first voltage and forming the third and fourth cured layers further comprises applying the pixel electrode with a third voltage having a level different from the level of the first voltage and the reference electrode with the second voltage.

The pixel electrode and the reference electrode are provided in the first and second areas.

The pixel electrode includes a first sub-pixel electrode disposed in the first area and a second sub-pixel electrode disposed in the second area.

One of each of the first and second sub-pixels includes an electrode pattern to define a plurality of domains in at least one of the first and the second areas.

The electrode pattern includes a trunk portion divining the domains and a plurality of branch portions arranged substantially in parallel to each other in each domain.

The liquid crystal molecules have a negative dielectric anisotropy and are vertically aligned.

The liquid crystal layer includes a photo-curable agent and the first and second cured layers are formed by irradiating an ultraviolet ray to the photo-curable agent.

The third and fourth cured layers are formed by irradiating an ultraviolet ray onto the photo-curable agent.

The irradiating of the light to the first area is performed while the first electric field is applied to the first area.

The irradiating of the light to the second area is performed while the second electric field is applied to the second area.

According to the above, the light is irradiated to the first area while the first electric field is applied to the liquid crystal layer, and then the light is irradiated to the second area while the second electric field is applied to the liquid crystal layer. Thus, the first liquid crystal molecules of the first area may be pre-tilted in the direction different from the direction in which the second liquid crystal molecules of the second area are pre-tilted.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a plan view showing a liquid crystal display panel according to an example embodiment of the present disclosure;

FIG. 2 is a perspective view showing one pixel among pixels shown in FIG. 1;

FIG. 3 is a flowchart showing a manufacturing process of a super vertical alignment (SVA) mode liquid crystal display panel;

FIG. 4 is a cross-sectional view showing a process of forming a first electric field in a first area shown in FIG. 3;

FIG. 5 is a cross-sectional view showing a process of forming first and second curing layers shown in FIG. 3;

FIG. 6 is a cross-sectional view showing a process of forming a second electric field in a second area shown in FIG. 3;

FIG. 7 is a cross-sectional view showing a process of forming third and fourth curing layers show in FIG. 3;

FIG. 8 is a cross-sectional view showing a liquid crystal display panel manufactured by the manufacturing method according to an example embodiment of the present disclosure; and

FIG. 9 is an enlarged plan view showing a pixel electrode shown in FIG. 2.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

In a patterned vertical alignment mode of the vertical alignment mode liquid crystal display, either one or both of a pixel electrode and a common electrode are patterned to form liquid crystal domains that align the liquid crystal molecules in different directions, so that a viewing angle of the liquid crystal display is improved.

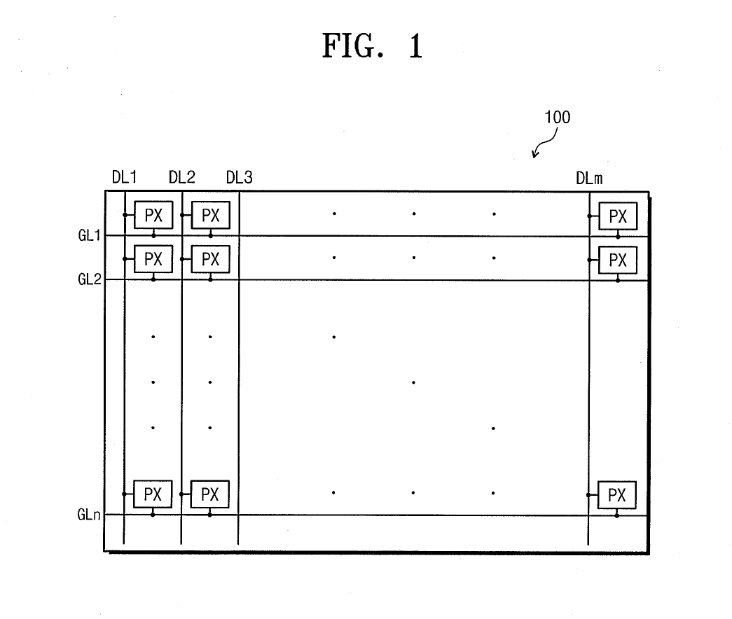

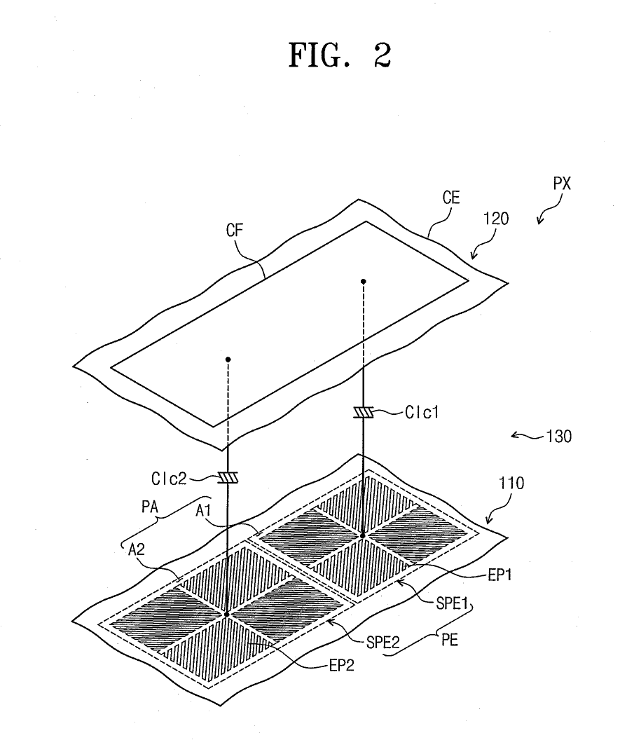

FIG. 1 is a plan view showing a liquid crystal display panel 100 according to an example embodiment of the present disclosure and FIG. 2 is a perspective view showing one pixel PX among pixels shown in FIG. 1.

Referring to FIGS. 1 and 2, the liquid crystal display panel 100 is connected to a plurality of signal lines and includes a plurality of pixels PX arranged in a matrix form. As shown in FIG. 1, the liquid crystal display panel 100 includes a first substrate 110, a second substrate 120 facing the first substrate 110, and a liquid crystal layer 130 interposed between the first and second substrates 110 and 120.

The signal lines are configured to include a plurality of gate lines GL1 to GLn and a plurality of data lines DL1 to DLm. The gate lines GL1 to GLn extend in a row direction and are arranged substantially in parallel to each other in a column direction. The data lines DL1 to DLm extend in the column direction and are arranged substantially in parallel to each other in the row direction.

The pixels PX have the same structure and function, and thus FIG. 2 shows only one pixel PX.

Referring to FIG. 2, each pixel PX includes first and second sub-pixels. The first sub-pixel includes a first liquid crystal capacitor C1c1 and the second sub-pixel includes a second liquid crystal capacitor C1c2.

The first substrate 110 includes a first sub-pixel electrode SPE1 as a first electrode of the first liquid crystal capacitor C1c1 and a second sub-pixel electrode SPE2 as a first electrode of the second liquid crystal capacitor C1c2.

The second substrate 120 includes a reference electrode CE as a second electrode of each of the first and second liquid crystal capacitors C1c1 and C1c2. The liquid crystal layer 130 interposed between the first and second substrates 110 and 120 serves as a dielectric substance of each of the first and second liquid crystal capacitors C1c1 and C1c2.

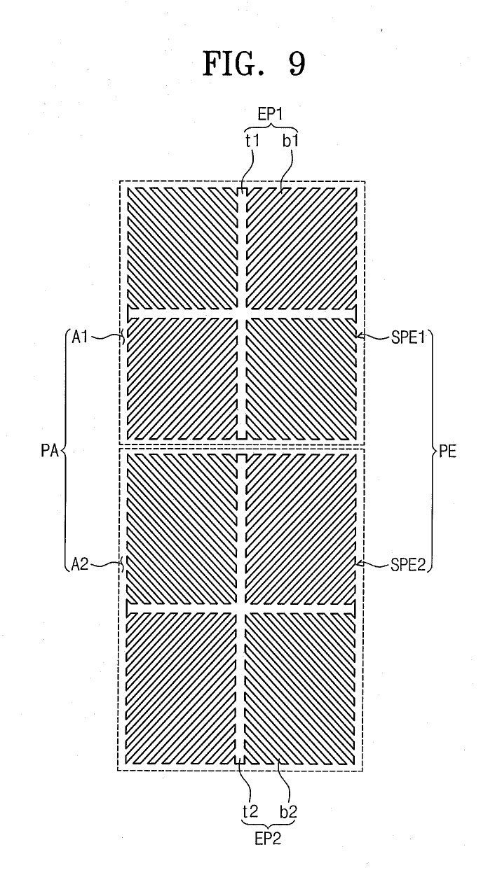

The first and second sub-pixel electrodes SPE1 and SPE2 are electrically insulated from each other and form a pixel electrode set PE. As an example, the first sub-pixel electrode SPE1 includes a first electrode pattern EP1 and the second sub-pixel electrode SPE2 includes a second electrode pattern EP2. The first and second electrode patterns EP1 and EP2 will be described in detail with reference to FIG. 9.

The pixel PX includes a pixel area PA. The pixel area PA includes a first area A1 in which the first sub-pixel electrode SPE1 is disposed and a second area A2 in which the second sub-pixel electrode SPE2 is disposed.

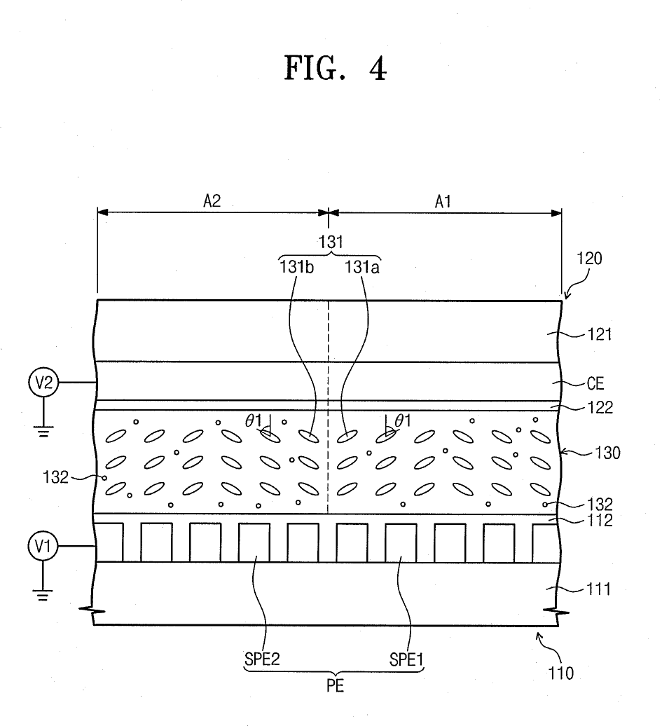

The reference electrode CE is disposed on the second substrate 120 to receive a reference voltage. Liquid crystal molecules 131 (refer to FIG. 4) included in the liquid crystal layer 130 have a negative dielectric anisotropy and are aligned such that long axes of the liquid crystal molecules can be aligned substantially perpendicular to major surfaces of the first and second substrates 110 and 120 when no electric field is applied thereto.

Meanwhile, each pixel PX is operated in a spatial division scheme that inherently displays one of primary colors, e.g., red, green, and blue, or in a time division scheme that alternately displays the primary colors according to a time lapse, and thus the liquid crystal display panel 100 may display a desired image. The second substrate 120 shown in FIG. 2 has a structure to which the spatial division scheme is applied, and thus the second substrate 120 includes a color filter CF that represents one of the primary colors and is disposed to correspond to each pixel PX. Different from the structure shown in FIG. 2, the color filter CF may be disposed on the first substrate 110.

Each pixel PX is electrically connected to a corresponding gate line of the gate lines GL1 to GLn and a corresponding data line of the data lines DL1 to DLm. Each pixel PX is turned on or turned off in response to a gate signal provided through the corresponding gate line. The turned-on pixel PX displays a gray-scale corresponding to a data voltage applied to the corresponding data line.

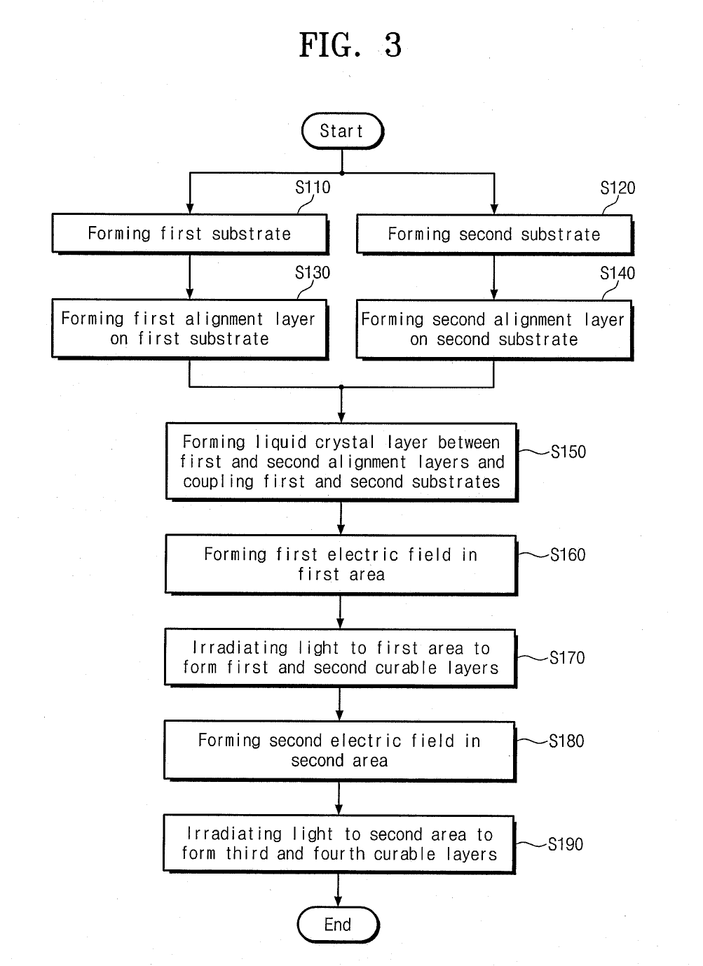

Hereinafter, a manufacturing process of the liquid crystal display panel 100 operated in a super vertical alignment (SVA) mode will be described in detail with reference to FIGS. 3 to 8.

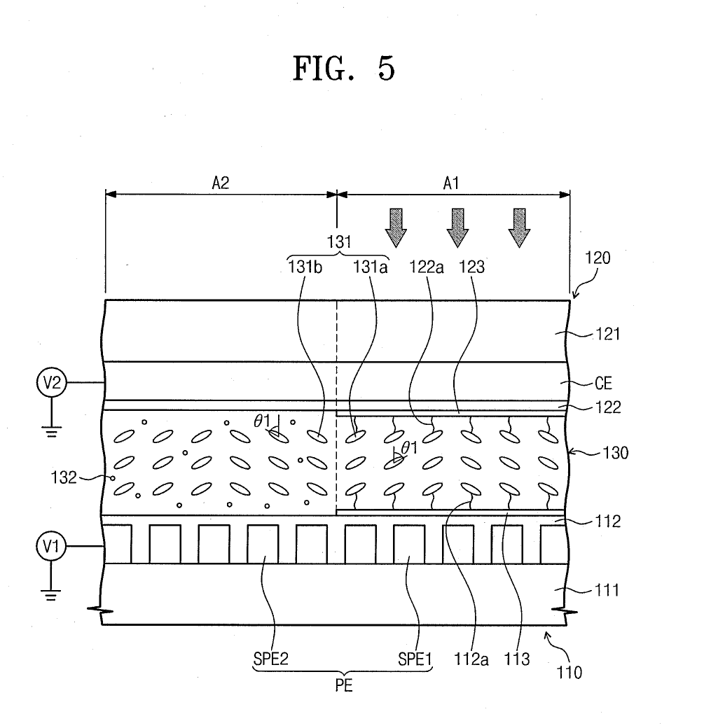

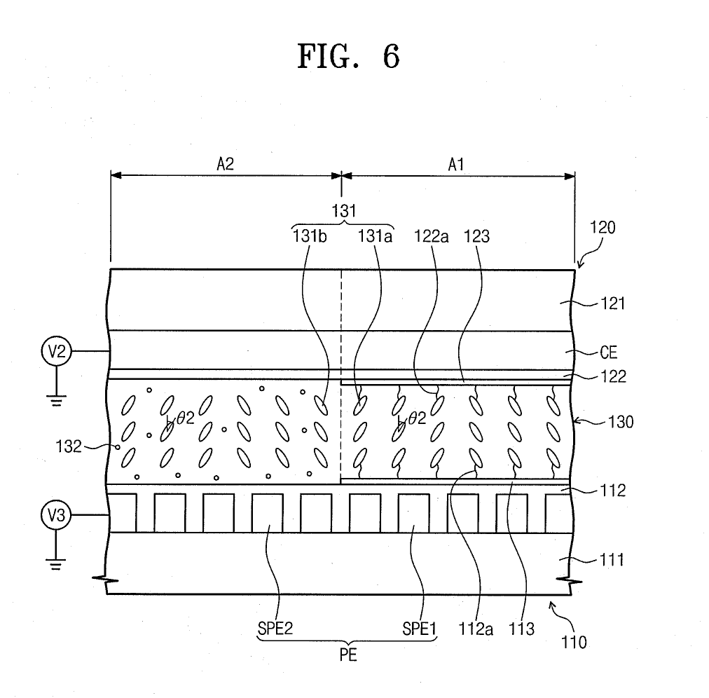

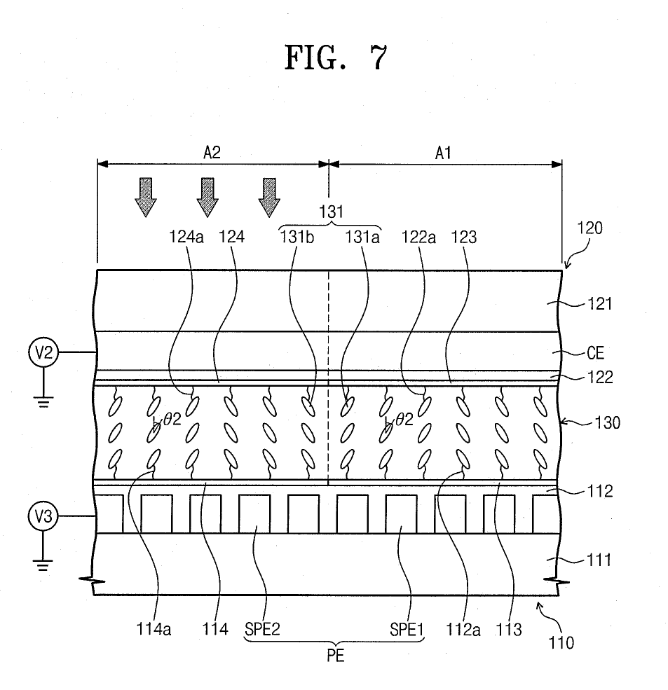

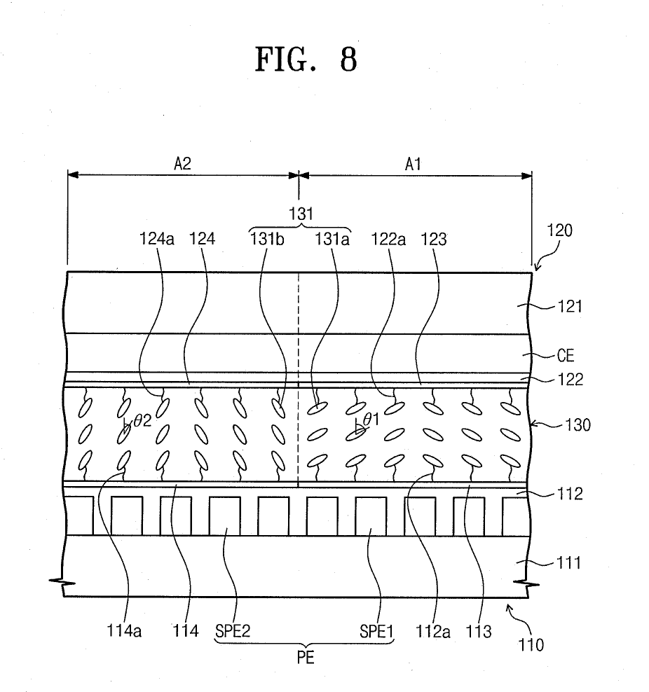

FIG. 3 is a flowchart showing the manufacturing process of the SVA mode liquid crystal display panel, FIG. 4 is a cross-sectional view showing a process of forming a first electric field in a first area shown in FIG. 3 (S160), FIG. 5 is a cross-sectional view showing a process of forming first and second curing layers shown in FIG. 3 (S170), FIG. 6 is a cross-sectional view showing a process of forming a second electric field in a second area shown in FIG. 3 (S180), FIG. 7 is a cross-sectional view showing a process of forming third and fourth curing layers shown in FIG. 3 (S190), and FIG. 8 is a cross-sectional view showing a liquid crystal display panel manufactured by the manufacturing method according to an example embodiment of the present disclosure.

Referring to FIGS. 3 and 4, the first and second substrates 110 and 120 of the liquid crystal display panel 100 are manufactured (S110 and S120).

As shown in FIG. 4, the first substrate 110 includes a first base substrate 111 and the pixel electrode set PE disposed on the first base substrate 111. As described above, the pixel electrode set PE includes the first sub-pixel electrode SPE1 disposed in the first area A1 and the second sub-pixel electrode SPE2 disposed in the second area A2.

The second substrate 120 includes a second base substrate 121 facing the first base substrate 111 while being coupled to the first base substrate 111 and the reference electrode CE disposed on the second base substrate 121 to face the pixel electrode set PE.

When the first and second substrates 110 and 120 are manufactured, a first alignment layer 112 is formed on the first substrate 110 (S130) and a second alignment layer 122 is formed on the second substrate 120 (S140). The first alignment layer 112 is disposed on the pixel electrode set PE and the second alignment layer 122 is disposed on the reference electrode CE.

The first and second alignment layers 112 and 122 are respectively formed on the first and second substrates 110 and 120 by an inkjet or roll-printing method. In addition, each of the first and second alignment layers 112 and 122 may be formed of a material used in a vertical alignment (VA) mode or a twisted nematic (TN) mode.

In embodiments, subsequently to arranging the first and second substrates, the liquid crystal layer 130 including the liquid crystal molecules 131 and a photo-curable agent 132 is formed between the first and second alignment layers 112 and 122. The liquid crystal molecules 131 include first liquid crystal molecules 131a provided to the first area A1 of the liquid crystal layer and second liquid crystal molecules 131b provided to the second area A2 of the liquid crystal layer.

The first and second substrates 110 and 120 are coupled to each other while the liquid crystal layer 130 is interposed between the first and second substrates 110 and 120 (S150), but they should not be limited thereto or thereby. In another embodiment, the liquid crystal layer 130 may be formed between the first and second alignment layers 112 and 122 after the first and second substrates 110 and 120 are coupled to each other.

The liquid crystal layer 130 includes a mixture of the liquid crystal molecules 131 and the photo-curable agent 132. When a content of the liquid crystal layer 130 is assumed to be 100 wt %, a content of the photo-curable agent 132 is about 1.0 wt % or less.

In the present example embodiment, the photo-curable agent 132 may be a reactive mesogen. The term of “mesogen” used herein means a photocrosslinkable low molecular weight or a high molecular weight copolymer including a mesogen group of a liquid crystal property. Examples of suitable reactive mesogens are those including acrylate, methacrylate, epoxy, oxethane, vinyl-ether, styrene, or thiolene groups. In addition, the reactive mesogen may be a material of a bar shape structure, a banana shape structure, a board shape structure, or a disc shape structure.

Although not shown in the figures, the liquid crystal layer 130 may further include a photo-initiator (not shown). The photo-initiator is in an amount of about 0.01 wt % to about 1 wt % with respect to the photo-curable agent 132. The photo-initiator absorbs a long wavelength ultraviolet ray and generates radicals to initiate a photopolymerization reaction of the photo-curable agent 132.

After the first and second substrates 110 and 120 are coupled to each other, the first and second substrates 110 and 120 are annealed at a temperature of about 100° C. to about 120° C. during a time period of about 60 minutes to about 80 minutes in order to improve orientation uniformity of the liquid crystal molecules 131.

When different voltages are respectively applied to the pixel electrode PE of the first substrate 110 and the reference electrode CE of the second substrate 120 after the first and second substrates 110 and 120 are coupled to each other, the first electric field is formed in the liquid crystal layer 130 (S160). As an example, a first voltage V1 is applied to the pixel electrode PE and a second voltage V2 different from the first voltage V1 is applied to the reference electrode CE.

When the first electric field is formed, the liquid crystal molecules 131 included in the liquid crystal layer 130 are aligned by the first electric field. In more detail, the first liquid crystal molecules 131a in the first area A1 are aligned substantially in parallel to an extending direction of features (for example, branches) of the first electrode pattern EP1 (refer to FIG. 2) when viewed in a plan view. The first liquid crystal molecules 131a are inclined at a first angle Θ1 with respect to a direction substantially perpendicular to the major surface of the first substrate 110. The first angle Θ1 is determined depending on intensity of the first electric field in a cross sectional view.

The second liquid crystal molecules 131b in the second area A2 are aligned substantially in parallel to an extending direction of features (for example, branches) of the second electrode pattern EP2 (refer to FIG. 2) when viewed in a plan view. The second liquid crystal molecules 131b are inclined at the first angle Θ1 with respect to the direction substantially perpendicular to the major surface of the first substrate 10 in a cross sectional view.

Then, as shown in FIG. 5, an electric field exposure process is performed on the liquid crystal layer 130 by irradiating light, e.g., an ultraviolet ray (UV) onto the liquid crystal layer 130 while the first electric field is formed. The light is irradiated onto the first substrate 110 and/or the second substrate 120. The light is provided to the first area A1 and not provided to the second area A2. As an example, although not shown in figures, a first mask (not shown) including a first opening formed therethrough to correspond to the first area A1 may be used. In more detail, when the first mask is disposed on the second substrate 120 to shadow-mask the second area A2 and the light is provided to an upper surface of the first mask, the light is provided only to the first area A1 and the light toward the second area A2 is blocked. As another example, the light may be provided only to the first area A1 by using a digital exposure unit while not providing the light to the second area A2.

When the light is irradiated onto the liquid crystal layer 130 in the first area A1 while the first electric field is formed, the photo-curable agent 132 provided to the first area A1 of the liquid crystal layer 130 is cured to have the same inclination angle as that of the first liquid crystal molecules 131a on the first and second alignment layers 112 and 122. As a result, first and second photo-cured layers 113 and 123 are respectively formed on the first and second alignment layers 112 and 122.

In embodiments, after forming the cured layers 113 and 123, although the electric field is not formed in the liquid crystal layer 130, side-chain polymers 112a and 122a of the first and second photo-cured layers 113 and 123 maintain directivity of first liquid crystal molecules 131a adjacent thereto. As described above, the first liquid crystal molecules 131a are pre-tilted in the direction substantially in parallel to the extending direction of features (for example, branches) of the first electrode pattern EP1 (refer to FIG. 2) when viewed in a direction perpendicular to the major surface of the first substrate by the polymers of the first and second photo-cured layers 113 and 123.

Referring to FIG. 6, a third voltage V3 is applied to the pixel electrode PE and the second voltage V2 is applied to the reference electrode CE. Accordingly, a second electric field is formed in the liquid crystal layer 130 by the second and third voltages V2 and V3 respectively applied to the reference electrode CE and the pixel electrode PE (S180). The third voltage V3 has a level different from that of the first voltage V1, and thus the intensity of the first electric field formed by a difference in level between the first and second voltages V1 and V2 is different from the intensity of the second electric field formed by a difference in level between the second and third voltages V2 and V3. In the present example embodiment, the intensity of the second electric field may be smaller than the intensity of the first electric field.

When the second electric field is formed, the liquid crystal molecules 131 included in the liquid crystal layer 130 are aligned by the second electric field. In more detail, the first liquid crystal molecules 131a in the first area A1 are aligned substantially in parallel to the extending direction of features (for example, branches) of the first electrode pattern EP1 (refer to FIG. 2) when viewed in a plan view. The first liquid crystal molecules 131a are inclined at a second angle Θ2 with respect to the direction substantially perpendicular to the major surface of the first substrate 110 in a cross sectional view.

The second angle Θ2 is determined depending on the intensity of the second electric field. In the present example embodiment, since the intensity of the second electric field is smaller than the intensity of the first electric field, the second angle Θ2 is smaller than the first angle Θ1.

The second liquid crystal molecules 131b in the second area A2 are aligned substantially in parallel to the extending direction of features (for example, branches) of the second electrode pattern EP2 (refer to FIG. 2) when viewed in a plan view. The second liquid crystal molecules 131b are inclined at the second angle Θ2 with respect to the direction substantially perpendicular to the first substrate 10 in a cross sectional view.

Then, as shown in FIG. 7, an electric field exposure process is performed on the liquid crystal layer 130 by irradiating the light to the liquid crystal layer 130 while the second electric field is formed. The light is irradiated onto the first substrate 110 and/or the second substrate 120. The light is provided to the second area A2 and not provided to the first area A1. As an example, although not shown in figures, a second mask (not shown) including a second opening formed therethrough to correspond to the second area A2 may be used. In more detail, when the second mask is disposed on the second substrate 120 to shadow-mask the first area A1 and the light is provided to an upper surface of the second mask, the light is provided only to the second area A2 and the light traveling toward to the first area A1 is blocked. As another example, the light may be provided only to the second area A2 by using the digital exposure unit without being provided to the first area A1.

When the light is irradiated onto the liquid crystal layer 130 in the second area A2 while the second electric field is formed, the photo-curable agent 132 provided to the second area A2 of the liquid crystal layer 130 is cured to have the same inclination angle as that of the second liquid crystal molecules 131b on the first and second alignment layers 112 and 122. As a result, third and fourth photo-cured layers 114 and 124 are respectively formed on the first and second alignment layers 112 and 122.

After forming the cured layers 114 and 124, although the electric field is not formed in the liquid crystal layer 130, side-chain polymers 114a and 124a of the third and fourth photo-cured layers 114 and 124 maintain directivity of second liquid crystal molecules 131b adjacent thereto. As described above, the second liquid crystal molecules 131b are pre-tilted in the direction substantially in parallel to the extending direction of features (for example, branches) of the second electrode pattern EP2 (refer to FIG. 2) when viewed in a direction perpendicular to the major surface of the first substrate by the polymers of the third and fourth photo-cured layers 114 and 124.

As shown in FIG. 8, when the electric field is not formed in the liquid crystal layer 130 of the liquid crystal display panel 100 manufactured by the above-mentioned method, the first liquid crystal molecules 131a of the first area A1 are pre-tilted at the first angle Θ1 and the second liquid crystal molecules 131b of the second area A2 are pre-tilted at the second angle Θ2.

As described above, the light is irradiated to the first area A1 while the first electric field is applied to the liquid crystal layer 130 to pre-tilt the first liquid crystal molecules 131a at the first angle Θ1, and then the light is irradiated to the second area A2 while the second electric field is applied to the liquid crystal layer 130 to pre-tilt the second liquid crystal molecules 131b at the second angle Θ2. As a result, the first liquid crystal molecules 131a are pre-tilted at the first angle Θ1 in the first area A1 and the second liquid crystal molecules 131b are pre-tilted at the second angle Θ2 in the second area A2.

As described above, when the liquid crystal molecules are pre-tilted in different angles from each other in accordance with the areas defined in the pixel, the visibility of the liquid crystal display panel 100 may be improved.

FIG. 9 is an enlarged plan view showing the pixel electrode shown in FIG. 2.

Referring to FIG. 9, the first electrode pattern EP1 of the first sub-pixel electrode SPE1 includes a first trunk portion t1 and a plurality of first branch portions b1 extending from the first trunk portion t1 in a radial shape, and thus the first area A1 is divided into a plurality of domains. The first trunk portion t1 has a cross shape, so that the first area A1 is divided into four domains by the first trunk portion t1. The first branch portions b1 extend substantially in parallel to each other and are arranged to be spaced apart from each other in each domain defined by the first trunk portion t1. As an example, the first branch portions b1 extend in a direction inclined at about 45 degrees with respect to the first trunk portion t1. In the first branch portions b1, a distance between two adjacent or immediately neighboring first branch portions b1 is measured in terms of a micrometer. The first liquid crystal molecules 131a (refer to FIG. 8) of the liquid crystal layer 130 (refer to FIG. 8) are pre-tilted in different directions in accordance with the domains by the first electrode pattern EP1.

The second sub-pixel electrode SPE2 includes a second trunk portion t2 and a plurality of second branch portions b2 extending from the second trunk portion t2 in a radial shape, and thus the second area A2 is divided into a plurality of domains. The second trunk portion t2 has a cross shape, so that the second area A2 is divided into four domains by the second trunk portion t2. The second branch portions b2 extend substantially in parallel to each other and are arranged to be spaced apart from each other in each domain defined by the second trunk portion t2. In the second branch portions b2, a distance between two adjacent second branch portions b2 to each other is measured in terms of a micrometer to form the second electrode pattern EP2. The second liquid crystal molecules 131b (refer to FIG. 8) of the liquid crystal layer 130 (refer to FIG. 8) are pre-tilted in different directions in accordance with the domains by the second electrode pattern EP2.

Although the example embodiments of the present invention have been described, it is understood that the present invention should not be limited to these example embodiments but various changes and modifications can be made by one ordinary skilled in the art within the spirit and scope of the present invention as hereinafter claimed.

What is claimed is:

1. A method of manufacturing a liquid crystal display panel, comprising:
forming a first substrate including a first base substrate and a first alignment layer;
forming a second substrate including a second base substrate and a second alignment layer, the second substrate opposing the first substrate;
forming a liquid crystal layer between the first and second alignment layers, the liquid crystal layer including a first area comprising first liquid crystal molecules and a second area comprising second liquid crystal molecules;
applying a first electric field to the first area of the liquid crystal layer;
irradiating light to the first area to form first and second cured layers over the first and second alignment layers, respectively, the first and second cured layers are configured to pre-tilt the first liquid crystal molecules at a first angle;
applying a second electric field having an intensity different from that of the first electric field to the second area; and
irradiating the light to the second area to form third and fourth cured layers over the first and second alignment layers, respectively, the third and fourth cured layers are configured to pre-tilt the second molecules at a second angle different from the first angle.

2. The method of claim 1, wherein the forming of the first and second cured layers comprises:
shadow-masking the second area using a first mask including a first opening formed therethrough and corresponding to the first area; and
irradiating the light to the first area,
wherein the forming of the third and fourth cured layers comprises:
shadow-masking the first area using a second mask including a second opening formed therethrough and corresponding to the second area; and
irradiating the light to the second area.

3. The method of claim 1, wherein the forming of the first and second cured layers comprises providing the light to the first area using a digital exposure unit while not providing the light to the second area, and the forming of the third and fourth cured layers comprises providing the light to the second area using the digital exposure unit while not providing the light to the first area.

4. The method of claim 1, wherein the forming of the first substrate comprises forming a pixel electrode between the first base substrate and the first alignment layer and the forming of the second substrate comprises forming a reference electrode between the second base substrate and the second alignment layer.

5. The method of claim 4, wherein, the forming of the first and second cured layers further comprises applying the pixel electrode with a first voltage and the reference electrode with a second voltage having a level different from a level of the first voltage; and
forming the third and fourth cured layers further comprises applying the pixel electrode with a third voltage having a level different from the level of the first voltage and the reference electrode with the second voltage.

6. The method of claim 5, wherein the pixel electrode and the reference electrode are provided in the first and second areas.

7. The method of claim 5, wherein the pixel electrode comprises a first sub-pixel electrode disposed in the first area and a second sub-pixel electrode disposed in the second area.

8. The method of claim 7, wherein one or each of the first and second sub-pixel electrodes comprises an electrode pattern to define a plurality of domains in at least one of the first and the second areas.

9. The method of claim 8, wherein the electrode pattern comprises a trunk portion dividing the domains and a plurality of branch portions arranged substantially in parallel to each other in each domain.

10. The method of claim 1, wherein the liquid crystal molecules have a negative dielectric anisotropy and are vertically aligned.

11. The method of claim 1, wherein the liquid crystal layer comprises a photo-curable agent and the first and second cured layers are formed by irradiating an ultraviolet ray to the photo-curable agent.

12. The method of claim 11, the third and fourth cured layers are formed by irradiating an ultraviolet ray to the photo-curable agent.

13. The method of claim 1, the irradiating of the light to the first area is performed while the first electric field is applied to the first area.

14. The method of claim 1, the irradiating of the light to the second area is performed while the second electric field is applied to the second area.

15. A method of manufacturing a liquid crystal display device, the method comprising:
providing an intermediate product comprising a first panel, a second panel and a liquid crystal layer disposed between the first and second panel, the liquid crystal layer comprising liquid crystal molecules and a photo-curable material, the intermediate product comprising a first area and a second area next to the first area when viewed in a direction perpendicular to a major surface of the first panel;
applying a first electric field to the liquid crystal layer;
irradiating light to the liquid crystal layer in the first area while applying the first electric field to cure the photo-curable material in the first area thereby forming cured layers over the first and second panels in the first layer and pre-tilting the liquid crystal molecules between the cured layers in the first area to have a first angle with respect to the direction;
applying a second electric field having an intensity different from that of the first electric field to the liquid crystal layer in the second area; and
irradiating light to the liquid crystal layer in the second area while applying the second electric field to cure the photo-curable material in the second area, thereby forming cured layers over the first and second panels in the second area and pre-tilting the liquid crystal molecules between the cured layers in the second area to have a second angle with respect to the direction, the second angle being different from the first angle,
wherein the light is not irradiated to the liquid crystal layer in the second area when irradiating the liquid crystal layer in the first area.

16. The method of claim 15, wherein the photo curable material comprises side chain liquid crystal polymer.

17. The method of claim 15, wherein the first panel comprises first and second pixel electrode and the second panel comprises a reference electrode, wherein the first area overlaps the first pixel electrode when viewed in the direction and the first electric field is applied between the first pixel electrode and the reference electrode, wherein the second area overlaps the second pixel electrode when viewed in the direction and the second electric field is applied between the second pixel electrode and the reference electrode.

18. The method of claim 15, wherein the first panel comprises a pixel electrode and the second panel comprises a reference electrode, wherein the first and second areas overlap first and second portions of the pixel electrode, respectively, when viewed in the direction, wherein the first and second electric fields are applied between the pixel electrode and the reference electrode.
